(19) United States
(12) Patent Application Publication
(10) Pub. No.: US 2011/0073579 A1
(43) Pub. Date: Mar. 31, 2011

(54) METHOD OF MANUFACTURING A STRUCTURE AT A SURFACE OF A METAL WORK PIECE

(76) Inventors: Josef Artelsmair, Wartberg (AT); Joerg Kazmaier, Thalheim bei Wels (AT); Uwe Kroiss, Wilhering (AT); Walter Stieglbauer, Manning (AT); Gernot Trauner, Buchkirchen (AT)

(21) Appl. No.: 12/736,952

(22) PCT Filed: Apr. 24, 2009
(86) PCT No.: PCT/AT2009/000165

§ 371 Date: Nov. 24, 2010

(30) Foreign Application Priority Data
May 28, 2008 (AT) A855/2008

(51) Int. Cl. B23K 9/00; B23K 9/095

(52) U.S. Cl. 219/137 R

(57) ABSTRACT

The invention relates to a method of manufacturing a structure (1) at a surface of a work piece (4), the structure (1) standing out from the surface, wherein a welding process (7) with an at least partially fusing filler material (2) is used, wherein an arc (3) is ignited during a welding cycle (8) of the welding process (7) between the filler material (2) guided in a welding torch (5) and the work piece (4), and wherein the heat input during the welding process (7) is adjusted by controlling the welding parameters. In accordance with the invention it is provided that the structure (1) is manufactured step by step from a plurality of individual elements (6), wherein each individual element (6) is manufactured in one welding cycle (8) of the welding process (7), and wherein a welding break (9) is made after each welding cycle (8).

The invention relates to a method of manufacturing a structure at a surface of a metal work piece, said structure standing out from the surface, wherein a welding process with an at least partially fusing filler material is used, wherein an arc is ignited during a welding cycle of the welding process between the filler material guided in a welding torch and the work piece, and wherein the heat input during the welding process is adjusted by controlling the welding parameters.

DE 100 57 187 A1 discloses a method of manufacturing sandwich structures between metal and non-metal materials, wherein, on a surface of a metal base body, an adhesive layer is applied onto which a preferably non-metal material is applied. The adhesive layer is produced from individual welding spots or anchor points, respectively, by a respective welding process, wherein, for forming a welding spot or anchor point, respectively, during the welding process the fusing of a preferably continuous welding wire is performed such that the welding spot or the anchor point formed has a preferably ball-like or mushroom-like shape at the surface of the base body.

It is a drawback in this method that the design of the welding spots or anchor points, respectively, is restricted to a ball-like or mushroom-like shape, and that hence no special geometries can be produced. Thus, such anchor points are suited only for particular joints of metal and non-metal materials. Substantially, only non-metal materials that are capable of being liquefied are adapted to be joined to metal materials that were formed in this manner, so that an embedding or extrusion coating, respectively, of the anchor points is possible. It is not possible to join non-metal materials of the group of fibre composites in an economic manner to such metal materials.

Also, such anchor points that have a rather blunt design can be impressed into pasty or solid materials, as it would be necessary with joints between two metal materials, with increased effort only.

The object of the invention therefore consists in providing an above-mentioned manufacturing method by which a surface structure may be produced which is adaptable to various applications in a flexible manner. Drawbacks of known methods are to be avoided or at least reduced.

The object of the invention is solved in that the structure is manufactured step by step by a plurality of individual elements, wherein each individual element is manufactured in one welding cycle of the welding process, and wherein a welding break is made after each welding cycle.

It is of advantage that it is possible to implement surface structures of any shapes, directions, and dimensions, and that the shapes of the structures can be adapted correspondingly to the respective applications. Thus, for instance, it is also possible to produce structures for the joint of two metal materials, or positioning aids and distance aids for this purpose, respectively. In the case of joints of non-metal materials, such as fibre composites, with metal materials, the fibres are, due to the structure adapted for this purpose, capable of surrounding same without difficulty. Thus, techniques such as weaving in, enmeshing, or piercing of non-woven fabrics or mats may be applied.

Likewise, it is possible by the step-wise manufacturing method in an advantageous manner to use, after a defined number of steps, another material as a filler material. This may also be performed in that the first steps are performed by a first welding torch with a first filler material, and the further steps with the other filler material by a further welding torch. Furthermore, different diameters may also be used for the filler material. It is also of advantage that an existing surface provided with structures may at any time be supplemented with further structures, or existing structures may be modified and supplemented, respectively. The fact that a defined period of time is waited between the manufacturing steps has the advantage that the previously welded individual element may cool down.

By the measure that the welding cycle is started with the ignition of the arc and is terminated prior to a welding break such that the forming of the arc is suppressed by a corresponding control of the welding parameters, it is achieved in an advantageous manner that the individual elements may cool down.

It is also of advantage that a CMT (cold metal transfer) welding process is used as a welding process, so that an exact control of the thermal input and the drop detachment is possible. Furthermore, structures with constant properties (such as the height) are achieved since the force during retraction of the filler material or of the welding wire, respectively, has always the same intensity.

Advantageously, one individual element per welding cycle is produced, wherein the individual element produced in the next welding cycle is joined to this individual element. Thus, the material and the diameter of the filler material may be varied during the forming of a structure.

If the number of welding cycles and the heat input per welding cycle are matched with the shape and the dimension of the structure, the period for the cooling down of the individual elements may be varied as a function of the shape and dimension of this structure.

It is also of advantage that the shape and the dimension of the individual elements of the structure are determined by means of the welding parameters per welding cycle. The amount of filler material required for the individual element is determined by the thermal input, so that the shape and dimension of the individual elements may be varied correspondingly.

In an automated welding process, the position of the welding torch is preferably adjusted after each welding cycle for the following welding cycle. This is preferably performed during the welding breaks. Thus, it can be achieved that the following individual elements of the structure are welded on the previously produced individual element at a defined angle, so that almost any shape of a structure may be produced.

The present invention will be explained in detail by means of the enclosed, schematic drawings.

There show:

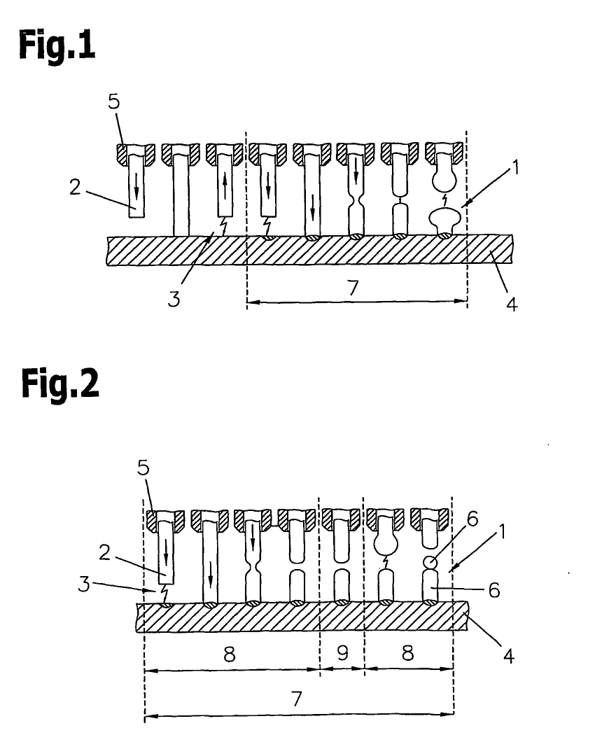

FIG. 1 a process for the manufacturing of a structure at the surface of a metal work piece, known from prior art;

FIG. 2 a process for the manufacturing of a structure of individual elements in accordance with the invention;

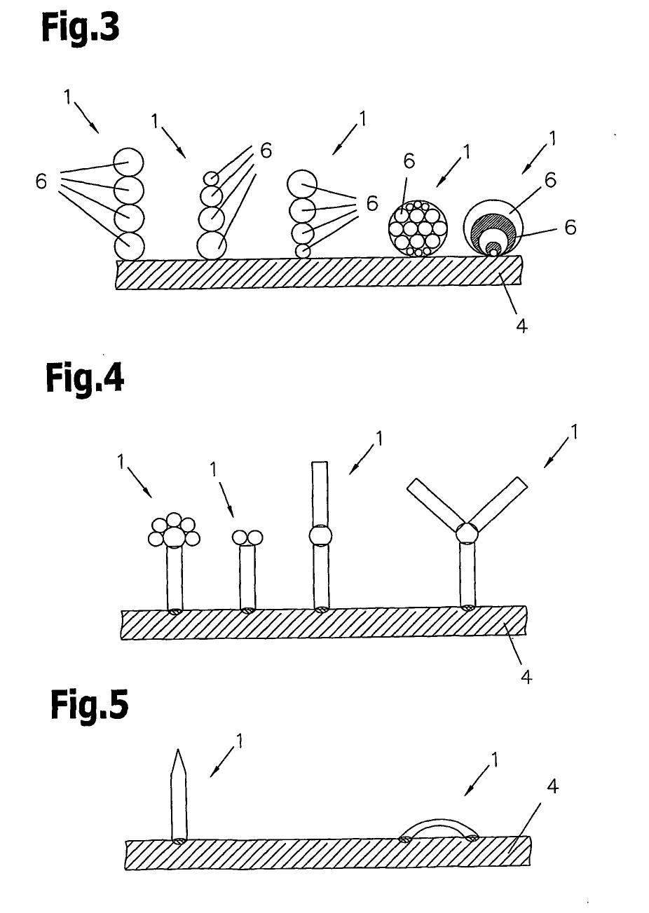

FIG. 3 different structures formed of individual elements in a ball shape;

FIG. 4 different structures formed of individual elements in combined shapes; and

FIG. 5 further structures formed of an individual element.

To begin with, it is noted that equal parts of the embodiments are provided with equal reference numbers.

FIG. 1 illustrates a structure 1 at the surface of a metal work piece 4, known from prior art. It is produced by a welding process 7, in particular an arc welding process, making use of a filler material 2 or a welding wire, respectively, that is guided in a welding torch 5. The filler material 2 is, as indicated by the arrows, moved toward the work piece 4 and/or away from the work piece 4, and an arc 3 is ignited between the filler material 2 and the work piece 4. The manufacturing of the structure 1 is performed during one single continuous welding process 7, i.e. without any welding break. The arc 3 between the filler material 2 and the work piece 4 is, for instance, ignited by a so-called contact ignition prior to the actual welding process 7. The arc 3 causes both a partial melting of the work piece 4 and of the filler material 2. Subsequently, the filler material 2 is moved toward the work piece 4 and welded therewith. By an appropriate control of the welding parameters, in particular the welding current and the wire motion, a bar is formed in that the filler material 2 is molten thoroughly substantially in the middle between the work piece 4 and the outlet end of the filler material 2 from the welding torch 5, also referred to as “stick-out”. In so doing, an arc 3 is again produced which melts the bar and forms a ball-like or mushroom-like structure 1. Similarly, substantially a ball as a structure 1 may also be manufactured directly on the surface of the work piece 4.

In accordance with the invention, arbitrary structures 1 may be manufactured with a welding process 7 in that the structure 1 is manufactured step by step of a plurality of individual elements 6. Thus, it is possible to manufacture the structure 1 in accordance with the desired use.

It is therefore possible to use the method according to the invention substantially for all and any applications. The structures 1 may be used as spacers, locating pins, fastening devices, rivets or eyes, to mention some applications by way of example. For the manufacturing of such structures 1, the welding process is adjusted individually. The method based on the basic principle of the invention, which will be described in detail in the following, is, however, always used.

The basic principle is based on the fact that a welding process 7 for the manufacturing of an arbitrary structure 1 at the surface of the work piece 4 is divided into at least two welding cycles 8 and one welding break 9, as is illustrated in FIG. 2. One welding cycle 8 serves to manufacture at least one individual element 6. During one welding cycle 8 it is required that one respective arc 3 is ignited. Between the applying or welding, respectively, of the individual elements 6 on the work piece 4, the welding break 9 of a defined duration is necessary. The purpose of this welding break 9 is that the previously manufactured individual element 6 is cooled down correspondingly, so that the individual element 6 manufactured in the following welding cycle 8 may be welded on the cooled-down individual element 6. The duration of the welding break 9 thus defines how the individual elements 6 join to each other. During a welding break 9 no arc 3 is ignited. Accordingly, the formation of an arc 3 is suppressed at the end of a welding cycle 8 in that the welding parameters, such as welding current, wire feeding speed, etc. are controlled correspondingly.

After the termination of the welding cycle 8—i.e. prior to the beginning of the welding break 9—a brief ignition of the arc 3 may also be performed. Thus, the surface of the individual element 6 may be prepared appropriately for the following welding cycle 8 in that the shape and surface of the individual element 6 are modified or adapted to the following individual element 6, respectively, by the brief ignition of the arc 3. As a matter of fact, such processing of an individual element 6 may also be performed in a welding cycle 8—i.e. after the welding break 9.

In this way, the structure 1 is formed by the individual elements 6. In so doing, the individual elements 6 are welded to each other such that the structure 1 to be manufactured is formed in correspondence with the respective application. To sum up, this means that each individual element 6 is manufactured in one welding cycle 8, wherein the manufacturing of an individual element 6 corresponds to one step, so that the structure 1 at the surface of the work piece 4 is formed step by step in accordance with the invention.

The individual elements 6 enable the forming of shapes of which the structure 1 is composed. A shape may be a ball or a bar. Thus, a ball shape as an individual element 6 may be formed of a drop of the filler material 2, so that substantially a small ball shape is produced. If a larger ball shape is to be produced, a filler material 2 or welding wire, respectively, of a larger diameter may be used, on the one hand. On the other hand, this larger ball shape may also be formed by a plurality of individual elements 6, wherein the following individual elements 6 are each welded on the previously produced individual element 6. Depending on the dimension of the ball shape, a plurality of individual elements 6 may also be welded directly in succession before a welding break 9 is made. Accordingly, a larger ball shape is formed by a plurality of individual elements 6. Of course, further shapes may be welded on such a ball shape in the following, so that the desired structure 1 is produced step by step. In so doing, it is decisive that the previously manufactured individual element 6 has cooled down to such an extent that the existing shape of the structure 1 is substantially not changed by the following individual element 6, and a corresponding melting for the following individual element 6 is performed nevertheless. This is predominantly achieved by the controlling of the thermal input and the welding break 9. Thus, pursuant to this method it is possible to compose structures 1 of arbitrary shapes, wherein according to the invention the shapes are produced step by step at least of one individual element 6—as in the case of the bar. It is, however, not only possible to form shapes such as the addressed ball or bar, respectively, with the individual elements 6, but also shapes like a hemisphere, a pyramid, an upside down pyramid, a peak or a spike, a match, etc. These shapes may now constitute the structure 1 directly or the structure 1 may be composed of such shapes, respectively. In so doing, the individual elements 6 may fuse with each other by corresponding melting such that the individual elements 6 manufactured step by step are no longer visible.

Preferably, a structure 1 is applied on a major area at the work piece 4 with an automated welding system. In so doing, the selected structure 1 is divided evenly or in correspondence with its use, respectively, on this area. Thus, a major amount of equal structures 1 is usually welded. Accordingly, the number of individual elements 6 required per shape, the respective welding parameter configuration, the “stick-out” (free wire end), the inert gas or inert gas mixture, respectively, the duration of the welding break 9, and possibly the work angle of the welding torch 5 are preferably determined by a welding test or by a simulation. The welding parameter configuration comprises the thermal input, in particular the penetration into the work piece 4 or into the previously manufactured individual element 6, the fusing performance, and the diameter of the filler material 2 or the welding wire, respectively, the wire feeding speed, the welding current intensity, and the welding voltage, to mention the most essential welding parameters. These welding parameters are correspondingly matched with each other, so that the shapes of the structure consisting of at least one individual element 6 may be manufactured. Thus, the dimension of the individual elements 6 is determined, which is in direct relation with the material detached from the filler material 2.

Such a parameter configuration is preferably stored in the welding device for each individual element 6 and/or for each shape and/or for each structure 1. Additionally, the duration of the welding break 9 required after each welded individual element 6 is stored. The result of this is an order of steps, so that it is possible to manufacture the structure 1 by means of the individual elements 6 step by step. The storage may, for instance, be performed as a combination of a welding cycle 8 with a subsequent welding break 9, as a so-called job for the complete structure 1, or as a functional sequence. In the case of an automated welding system, the required position of the welding torch 5 may additionally be stored, so that the following individual element 6 is welded with the appropriate angle. The orientation of the welding torch 5 is preferably carried out in the welding break 9.

The process of manufacturing an area of structures 1 may be arranged in a very individual manner and/or is adapted to the respective application. If, for instance, different materials are required for the filler material 2 for the manufacturing of a structure 1, all the structures 1 of the area may preferably initially be welded with the first material, and subsequently with the second one. Of course, two welding torches 5 may also be used for this purpose. In analogy, this may also be applied when different welding processes 7 are used with a structure 1.

As examples, different structures 1 that can be manufactured with the afore-described method according to the invention will be described in the following figures. All the figures each illustrate sections of the three-dimensional structures 1.

FIG. 3 shows different structures 1 that are composed of individual elements 6 in ball shape.

In correspondence with the dimension of the ball shapes, they are each manufactured of a drop of the filler material 2, or the ball shape is formed of a plurality of individual elements 6, as already mentioned before. It is also conceivable that the dimension of the ball shapes is increasing or decreasing. Of course, the numbers and dimensions of the ball shapes may be chosen arbitrarily.

If a ball shape is required that can no longer be implemented with a drop of the filler material 2 by controlling the welding parameters, the ball shape is manufactured of a plurality of small ball shapes, i.e. a plurality of individual elements 6, as results from the first ball shape in FIG. 3. Such a ball shape may, however, preferably also be manufactured such that the first individual element 6 is substantially manufactured as a ball shape, and the further individual elements 6 enclose the afore-manufactured individual element 6 or the afore-manufactured individual elements 6, respectively, at the top and at the sides. By means of a correspondingly adapted thermal input it may be achieved that the required dimension of the ball is produced, as may be seen from the second ball shape in FIG. 3.

Likewise, a pyramid or an upside down pyramid (not illustrated) may be manufactured by a corresponding combination of ball shapes of different sizes. To accelerate the manufacturing of such shapes, at least one bar may, of course, also be used to which corresponding ball shapes are welded, so that the desired shape is produced.

A structure 1 is also possible by combining shapes, such as one or a plurality of bar(s) and ball shapes, as is illustrated in FIG. 4. Here, too, each shape consists of at least one individual element 6, wherein in particular the dimension of the ball shape is controlled by the welding parameters or is produced in the manner described above with respect to FIG. 3.

In the shapes pursuant to FIG. 4, the respective first individual element 6 is formed as a bar. The bar is formed in accordance with FIG. 2, i.e. consists substantially of a defined length of the filler material 2 or welding wire, respectively. The diameter of the bar may be varied across the diameter of the filler material 2.

One or a plurality of ball shapes may be placed onto the bar. For instance such that a plurality of ball shapes form a hemisphere.

Likewise, at least two ball shapes may be placed onto a bar and/or be welded laterally thereto, so that substantially a T-shape is produced.

Correspondingly, a plurality of bars may be combined with at least one ball shape. Thus, a ball shape may be welded onto a bar, with a bar being in turn placed onto the ball. Likewise, two bars may be placed onto the ball shape, so that a Y-shape is formed. Correspondingly, further bars may be welded onto the ball shape, so that the structure 1 of a funnel is produced. Of course, such structures 1 may also be supplemented as desired, for instance, to form the shape of a cross.

These structures 1 thus clearly show that the shapes in accordance with the invention are composed of a plurality of individual elements 6, and that the structure 1 is produced step by step.

A bar may also be composed of two individual elements 6. In this respect, the bars are each formed by a defined length of the filler material 2. The substantial difference between the bars is the material used for the filler material 2. Here, a particularly rigid material is used for the bar that is joined to the work piece 4, whereas a softer material is, for instance, used for the bar placed onto this bar. The advantage of this is that such a structure 1 may also be used as a rivet. The softer bar is smashed or bent aside appropriately, so that the joining of a portion with the work piece 4 is given.

Another shape for the structure 1 may also be a peak, as is shown in FIG. 5. Here, it is of substantial importance that the welding parameters current, voltage, and wire feeding speed as well as inert gas, and “stick-out” are defined and used such that the filler material 2 is constricted in a so-called pasty condition. In this condition the filler material 2 may be torn to form a peak, so that a peak is produced as a structure 1. Substantially, a bar is produced which does not, as described already before, tear straightly, but tears by retracting of the filler material 2 and forms a peak. With such a controlling of the welding parameters it is substantial that they are applied for a defined duration before they are changed to the next value. Accordingly, the structure 1 in the shape of a peak is manufactured in one step.

Of course, the peak may also be manufactured in a plurality of steps. For instance such that initially a bar that is torn straightly is manufactured, and subsequently the peak is placed thereon, as described before.

Likewise, the peak may constitute a shape of a structure 1. Thus, for instance, in the Y-shape of the structure 1 illustrated in FIG. 4, the bars placed onto the ball shape and torn straightly may be replaced by respective peaks.

In general, the peak has the advantage that all the materials belonging to the group of fibre composites, which are preferably joined to the work piece 4 by the structures 1, may lay themselves around the structures 1 without difficulties.

Similar to the manufacturing of a peak, an eye may also be manufactured. In this respect, the procedure starts substantially as with a bar, and at least part thereof is transferred to a pasty condition, so that the bar is adapted to be curved by an appropriate motion of the welding torch 5. Subsequently, the bar is separated from the filler material 2. In the next step, the free end of the bar is in turn joined to the work piece 4, as illustrated in FIG. 5, or to a structure 1.

This method, i.e. transferring a bar to a pasty condition, may also be used to form a specific shape of a structure 1. For instance such that an L-shape is formed of a bar. On this shape, again, an arbitrary shape may be welded.

It is further possible that the bar is welded to the work piece 4, whereupon, depending on the “stick-out”, a heating of the filler material 2 or welding wire, respectively, at a particular position is performed, so that the filler material 2 is heated and is thus adapted to be easily deformed in this position. For the deformation, a corresponding motion with the welding torch 5 is performed, and subsequently it is possible to fuse the filler material 2. Thus, it is easily possible to manufacture a hook.

With respect to the figures described it is noted in summary that they merely illustrate a small excerpt from the possibilities that may be produced by the method according to the invention. Such a variety may in particular be achieved when a CMT (cold metal transfer) welding process is used. In this case, in particular an exact control of the thermal input, the drop detachment, and a precise force control above all during the thorough melting or tearing through, respectively, of the bar formed of the filler material 2 or the welding wire, respectively, is possible, so that almost any shape of a structure 1 may be manufactured.

In general, it is noted that such structures 1 are preferably used for joints between metals and plastics, in particular carbon fibre reinforced plastics. However, metal-metal joints or applications as initially mentioned may also be implemented.

1-9. (canceled)

10. A method of manufacturing a three-dimensional structure (1) at a surface of a metal work piece (4), said structure (1) standing out from the surface, wherein a welding process (7) with an at least partially fusing filler material (2) is used, wherein an arc (3) is ignited during a welding cycle (8) of said welding process (7) between said filler material (2) guided in a welding torch (5) and said work piece (4), and wherein the heat input during said welding process (7) is adjusted by controlling the welding parameters, wherein said structure (1) is manufactured step by step from a plurality of individual elements (6), wherein each individual element (6) is manufactured in one welding cycle (8) of said welding process (7) from said filler material (2), and wherein a welding break (9) is made after each welding cycle (8), wherein each welding cycle (8) is started with the ignition of said arc (3) and is terminated prior to said welding break (9) such that the forming of said arc (3) is suppressed by an appropriate control of the welding parameters, and one individual element (6) is manufactured per welding cycle (8) and the individual element (6) manufactured in the next welding cycle (8) is joined with said individual element (6).

11. The method according to claim 10, wherein a CMT welding process is used as said welding process (7).

12. The method according to claim 10, wherein the number of welding cycles (8) and the heat input per welding cycle (8) are matched with the shape and dimension of said structure (1).

13. The method according to claim 10, wherein the shape and dimension of said individual elements (6) of said structure (1) are determined by means of the welding parameters per welding cycle (8).

14. The method according to claim 10, wherein the amount of filler material (2) required for each individual element (6) is determined by the heat input per welding cycle (8).

15. The method according to claim 10, wherein with an automated welding process (7) the position of said welding torch (5) is adjusted after each welding cycle (8) for the following welding cycle (8).

16. The method according to claim 15, wherein the position of said welding torch (5) is adjusted during said welding breaks (9).
